(19) United States
(12) Patent Application Publication
(10) Pub. No.: US 2009/0322991 A1
(43) Pub. Date: Dec. 31, 2009

(54) Illuminating Device and Liquid Crystal Display

(75) Inventor: Yasuhiro Furusawa, Osaka (JP)

Correspondence Address: HARNESS, DICKEY & PIERCE, P.L.C., P.O. BOX 8910, RESTON, VA, 20195, US

(73) Assignee: SHARP KABUSHIKI KAISHA, Osaka-shi, Osaka (JP)

(21) Appl. No.: 12/309,525

(22) PCT Filed: Jun. 6, 2007
(86) PCT No.: PCT/JP2007/061422

§ 371 Date: Jan. 22, 2009

(30) Foreign Application Priority Data
Oct. 18, 2006 (JP) 2006-284359

(51) Int. Cl. G02F 1/1335; H05B 41/36; G09G 5/00

(52) U.S. Cl. 349/70; 315/149; 345/102; 345/207

(57) ABSTRACT

In one embodiment of the present invention, a lighting unit includes a hot-cathode fluorescent lamp including a filament electrode that emits a thermoelectron, an optical sensor for detecting an electromagnetic wave emitted by the filament electrode, and a driving circuit for controlling the driving of the hot-cathode fluorescent lamp based on a detected result of the optical sensor. The arrangement makes it possible to provide a lighting unit that can promptly detect an abnormality caused in the hot-cathode fluorescent lamp.

### TECHNICAL FIELD

The present invention relates to a lighting unit that optically detects an abnormality caused in a hot-cathode fluorescent lamp and to a liquid crystal display apparatus utilizing the lighting unit as a backlight.

### BACKGROUND ART

A backlight is used as a light source for displaying an image on a liquid crystal display panel (hereinafter, referred to as LCD panel) of a liquid crystal television, a liquid crystal display apparatus, a liquid crystal display monitor, or the like. The backlight serves to supply light onto an entire surface of the LCD panel. A light-emitting device used in such a backlight encompasses fluorescent lamps such as a hot-cathode fluorescent lamp: HCFL device and a cold-cathode fluorescent lamp: CCFL device, and an LED.

The hot-cathode fluorescent lamp excels in luminescence efficiency as compared to other light-emitting devices and emits high-intensity light by use of a relatively low voltage. As such, the hot-cathode fluorescent lamp is widely used. The hot-cathode fluorescent lamp is arranged such that a filament electrode is provided inside each end of a cylindrical glass tube having an inner wall coated with a fluorescent material. The filament electrode holds an emitter made of BaO, CaO, SrO, and/or the like.

The following describes how the hot-cathode fluorescent lamp emits light. In order that the filament electrode may be preheated, an electric current is passed through the filament electrode before the hot-cathode fluorescent lamp starts emitting light. Due to the preheating, the emitter emits thermoelectrons in the glass tube. When a high voltage is applied across the filament electrodes each provided inside each end of the glass tube, the thermoelectrons are drawn to an anode. A discharge is thus initiated. When the thermoelectrons drawn to the anode collide with mercury sealed in the glass tube, ultraviolet rays are emitted. The ultraviolet rays excite the fluorescent material with which the inner wall of the glass tube is coated. The fluorescent material thereby emits visible light specific to the fluorescent material.

At a late period of a life of the hot-cathode fluorescent lamp, the emitter of the filament electrode is exhausted because of consumption, fly loss, etc. of the emitter. This increases a cathode fall voltage in the filament electrode. As a result, the filament electrode generates an extremely high temperature, thereby glowing. Also in a period other than the late period of the life, an abnormality such as a disconnection of the filament electrode would occur in the hot-cathode fluorescent lamp. The disconnection of the filament electrode leads to a local arc discharge. As a result, the filament electrode generates a high temperature.

As described above, the filament electrode generates a high temperature in a case where an abnormality is caused in the hot-cathode fluorescent lamp. Consequently, a temperature exceeding its heat tolerance is applied, for example, on a peripheral member such as a base made of a synthetic resin and used for blocking an opening provided at each end of the glass tube of the hot-cathode fluorescent lamp. This can cause the peripheral member to deform, melt, smoke, and/or undergo the like problem. In a case where the hot-cathode fluorescent lamp is used, for example, as a backlight of a liquid crystal display apparatus, the heat emitted by the filament electrode adversely affects a member, a circuit, etc. of the liquid crystal display apparatus. Therefore, in a case where an abnormality is caused in the hot-cathode fluorescent lamp, it is desirable to promptly detect the abnormality and control the driving of the hot-cathode fluorescent lamp, so that heat generation of the filament electrode is suppressed.

In view of the problem, Patent Document 1 and Patent Document 2 each describe means for detecting a heat emitted by the filament electrode in a case where an abnormality is caused in the hot-cathode fluorescent lamp.

Patent Document 1 describes an arrangement in which a lead wire provided at each end of a fluorescent tube is electrically connected to a thermal fuse and an electrode. At a late period of a life of the fluorescent tube, a temperature of one electrode of the fluorescent tube increases. In a case where the temperature of the one electrode exceeds a rated temperature of the thermal fuse, the thermal fuse is disconnected by melting. This blocks current supply to the fluorescent tube. As a result, this makes it possible to protect a backlight unit having the fluorescent tube and electronic parts in a liquid crystal television from a failure due to the heat.

Patent Document 2 describes an arrangement in which a thermal sensor is provided in the vicinity of a base of each end of a straight-tube fluorescent lamp. In a case where the thermal sensor detects a temperature exceeding a reference temperature because of a temperature increase of the straight-tube fluorescent lamp, an output of an inverter circuit is decreased in order that current supply to the fluorescent lamp may be reduced. This makes it possible to prevent a temperature of the base from increasing to a temperature that causes thermal deformation of the base.

[Patent Document 1] Japanese Unexamined Patent Publication, Tokukaihei, No. 6-67175 (date of publication: Mar. 11, 1994)

[Patent Document 2] Japanese Unexamined Patent Publication, Tokukaihei, No. 11-238591 (date of publication: Aug. 31, 1999)

### DISCLOSURE OF INVENTION

According to the art described in Patent Document 1 and the art described in Patent Document 2, a thermal fuse or a thermal sensor (hereinafter, both correctively referred to as temperature sensor) is used for detecting the heat emitted by a filament electrode, so that an abnormality caused in the hot-cathode fluorescent lamp can be detected.

That is, according to the conventional arts, the heat emitted from the filament electrode is transmitted to the temperature sensor, and the temperature sensor detects the heat, so that an abnormality caused in the hot-cathode fluorescent lamp is detected. As such, according to the conventional arrangements, it is impossible to detect an abnormality of a light source until the heat is transmitted to the temperature sensor.

More specifically, in a case where the temperature sensor is provided in a space outside the hot-cathode fluorescent lamp, the temperature sensor cannot detect an abnormality caused in the hot-cathode fluorescent lamp until a temperature in the space reaches a detection temperature of the temperature sensor. Also, in a case where the temperature sensor is provided on an outer surface of the hot-cathode fluorescent lamp, the temperature sensor cannot detect an abnormality caused in the hot-cathode fluorescent lamp until a surface temperature of the hot-cathode fluorescent lamp reaches the detection temperature of the temperature sensor.

As described above, according to the arts described in Patent Document 1 and Patent Document 2, it is difficult to promptly detect an abnormality caused in the hot-cathode fluorescent lamp because the abnormality is detected by detecting the heat emitted from the filament electrode. This leads to a problem that the heat emitted from the filament electrode is transmitted to a peripheral member provided in the vicinity of the hot-cathode fluorescent lamp, thereby causing the peripheral member to melt, smoke, and/or undergo the like problem.

In view of the problem, an object of the present invention is to provide a lighting unit that can promptly detect an abnormality caused in a hot-cathode fluorescent lamp.

In order to attain the object, a lighting unit of the present invention includes: a light source having filament electrodes emitting thermoelectrons; an optical sensor for detecting an electromagnetic wave emitted by the filament electrodes; and driving means for controlling driving of the light source, based on a detected result of the optical sensor.

In a case where an abnormality is caused in the light source having the filament electrode that emits a thermoelectron, the filament electrode, emits an electromagnetic wave that is different from an electromagnetic wave to be emitted in a normal state. As such, the arrangement allows the lighting unit of the present invention to cause the optical sensor to detect an electromagnetic wave emitted from the filament electrode, and to control the driving circuit based on the detected result. For example, in a case where a detected result of the optical sensor indicates an electromagnetic wave that is emitted in a case where an abnormality is caused in the light source, the driving means terminates based on the detected result the driving of the light source. As for how the driving means controls the driving of the light source, the driving means not only terminates the driving of the light source, but, according to an electromagnetic wave emitted from the filament electrode, the driving means can also temporarily halt the driving of the light source, decrease an output of the light source, etc.

According to the conventional arrangements, an abnormality caused in the light source is detected by detecting a heat emitted from the filament electrode. As such, it is impossible to detect the abnormality caused in the light source until the heat emitted from the filament electrode reaches the sensor. In contrast, the lighting unit of the present invention causes the optical sensor to detect an electromagnetic wave emitted from the filament electrode, thereby detecting an abnormality caused in the light source. This makes it possible to promptly detect the abnormality caused in the light source. As a result, in a case where a peripheral member made of a material such as a resin is provided in the vicinity of the lighting unit of the present invention, this makes it possible to prevent the peripheral member from deforming, melting, smoking, and/or the like, because of the heat generated by the filament electrode in the light source.

The lighting unit of the present invention may be arranged such that the light source includes each of the filament electrodes inside each of both ends of a cylindrical glass tube; and the glass tube has an inner wall coated with a fluorescent material, except for a part in the vicinity of the filament electrode.

In order that the light source emits light, the inner wall of the glass tube of the light source is coated with the fluorescent material. Unfortunately, the fluorescent material with which the inner wall of the glass tube is coated intercepts a part of an electromagnetic wave emitted from the filament electrode. In addition, in the vicinity of the filament electrode, the fluorescent material with which the inner wall of the glass tube is coated does not greatly contribute to light emission of the light source. Therefore, the arrangement of the present invention makes it possible to prevent the fluorescent material with which the inner wall of the glass tube is coated from absorbing the electromagnetic wave emitted from the filament electrode. As a result, the optical sensor can detect more surely with higher accuracy the electromagnetic wave emitted from the filament electrode.

The lighting unit of the present invention may be arranged such that the optical sensor detects a change in intensity of visible light having a wavelength in a range from approximately 570 nm to approximately 590 nm.

In a case where an abnormality is caused in the light source, the filament electrode emits visible light in an orange spectrum, which visible light is different from light to be emitted in the normal state. The visible light in the orange spectrum has a wavelength in a range from approximately 570 nm to approximately 590 nm. Accordingly, the optical sensor preferably can detect a change in intensity of the visible light having a wavelength in the range from approximately 570 nm to approximately 590 nm. As such, with the arrangement of the present invention, the lighting unit of the present invention can detect by the optical sensor the visible light in the orange spectrum, which visible light is emitted from the filament electrode, in a case where an abnormality is caused in the light source. Therefore, in a case where an abnormality is caused in the light source, the lighting unit of the present invention can surely detect by the optical sensor the abnormality and control the driving of the light source.

The optical sensor is arranged so as to detect a change in intensity of the visible light having a wavelength in the range from approximately 570 nm to approximately 590 nm. As such, the optical sensor can be positioned relatively freely as compared to the conventional arrangement in which an abnormality caused in the light source is detected by a temperature sensor.

The lighting unit of the present invention may be arranged such that the driving means terminates the driving of the light source in a case where the optical sensor detects that the intensity of the visible light having the wavelength in the range from approximately 570 nm to approximately 590 nm exceeds a predetermined threshold.

In a case where an abnormality is caused in the light source, the filament electrode emits the visible light that has a wavelength in the range from approximately 570 nm to approximately 590 nm and has an intensity exceeding a predetermined threshold. As such, according to the arrangement of the present invention, in a case where the optical sensor detects that an intensity of the visible light having a wavelength in the range from approximately 570 nm to approximately 590 nm exceeds the predetermined threshold, the driving means terminates the driving of the light source, based on the detected result. As a result, in a case where an abnormality is caused in the light source, the lighting unit of the present invention can surely detect by the optical sensor the abnormality and control the driving of the light source.

The lighting unit of the present invention may be arranged such that the optical sensor detects a change in intensity of infrared rays having a wavelength in a range from approximately 0.8 μm to approximately 10 μm.

In a case where an abnormality is caused in the light source, the filament electrode generates heat. Accordingly, the filament electrode emits infrared rays having an intensity that is different from an intensity in the normal state. An emission intensity of the infrared rays differs according to a temperature of the heat generated by the filament electrode. For the detection of a difference between different emission intensities, it is preferable that a wavelength of infrared rays falls in a range from approximately 4 μm to approximately 10 μm. However, it is also possible to detect an abnormality caused in the light source, using a sensor for an infrared remote control that emits infrared rays having a wavelength of 0.8 μm, because increasing an output gain of the sensor makes significant a difference between intensities of the infrared rays emitted from the filament electrode. This makes it possible to inexpensively manufacture the lighting unit. Thus, according to the arrangement of the present invention, the optical sensor can detect the infrared rays emitted from the filament electrode in a case where an abnormality is caused in the light source. As a result, it is possible to surely control the driving of the light source in a case where an abnormality is caused in the light source.

The optical sensor is arranged so as to detect a change in intensity of the infrared rays having a wavelength in the range from approximately 0.8 μm to approximately 10 μm. As such, the optical sensor can be positioned relatively freely as compared to the conventional arrangement in which an abnormality caused in the light source is detected by a temperature sensor.

The lighting unit of the present invention may be arranged such that the driving means terminates the driving of the light source in a case where the optical sensor detects that the intensity of the infrared rays having the wavelength in the range from approximately 0.8 μm to approximately 10 μm exceeds a predetermined threshold.

In a case where an abnormality is caused in the light source, the filament electrode emits the infrared rays that have a wavelength in the range from approximately 0.8 μm to approximately 10 μm and have an intensity exceeding a predetermined threshold. As such, according to the arrangement of the present invention, in a case where the optical sensor detects that an intensity of the infrared rays having a wavelength in the range from approximately 0.8 μm to approximately 10 μm exceeds the predetermined threshold, the driving means terminates the driving of the light source, based on the detected result. As a result, in a case where an abnormality is caused in the light source, the lighting unit of the present invention can surely detect by the optical sensor the abnormality and control the driving of the light source.

The lighting unit of the present invention may include notifying means for notifying, to the outside, that an abnormality is caused in the light source, the notifying means performing the notification in a case where the driving means terminates the driving of the light source.

The arrangement makes it possible to notify a user etc. of the lighting unit of the present invention that an abnormality is caused in the light source. For example, in a case where the lighting unit of the present invention is provided in a liquid crystal display apparatus, displaying a notice that an abnormality is caused in the light source makes it possible to notify a user etc. of the liquid crystal display apparatus that the abnormality is caused in the light source. This allows the user etc. to promptly deal with the abnormality. As a result, this prevents a problem that the heat generated by the filament electrode affects a peripheral member etc. provided in the vicinity of the lighting unit.

The lighting unit of the present invention may include ultraviolet absorption means on that part of the inner wall of the glass tube, which is uncoated with the fluorescent material.

The light source emits light in such a manner that a discharge is caused by the filament electrode, thereby ultraviolet rays being emitted, and the ultraviolet rays activate the fluorescent material with which the inner wall of the glass tube is coated, thereby the visible light specific to the fluorescent material being emitted by the fluorescent material. In a case where, for example, a peripheral member made of a material such as a resin is provided in the vicinity of the lighting unit of the present invention, the peripheral member becomes deteriorated by being irradiated with the ultraviolet rays. In view of this, the arrangement of the present invention makes it possible to absorb by the ultraviolet absorption means ultraviolet rays emitted from the light source. As a result, this makes it possible to prevent deterioration of the peripheral member that is made of a material such as a resin and is provided in the vicinity of the lighting device of the present invention.

The lighting unit of the present invention may be arranged such that: at least the both ends of the glass tube of the light source are held by a holding table; and the optical sensor is mounted on the holding table.

In general, the light source is held by a holding table or the like because the light source is formed of a cylindrical glass tube. The optical sensor is provided on an outer wall of the glass tube of the light source or provided in a space outside the light source. In a case where the optical sensor is provided in the space outside the light source, the optical sensor is held by an optical sensor holding table or the like. The arrangement of the present invention combines the holding table for holding the light source and the optical sensor holding table. The arrangement makes it possible to reduce the number of members of the lighting unit of the present invention. In addition, the arrangement makes it possible to position the optical sensor in the vicinity of the filament electrode. This allows the optical sensor to detect with high sensitivity an abnormality caused in the light source.

A liquid crystal display apparatus of the present invention includes, as a backlight, the lighting unit described above.

With the arrangement, in a case where an abnormality is caused in the backlight in the liquid crystal display apparatus, the liquid crystal display apparatus can detect promptly and surely the abnormality caused in the light source, independently of a position to which the optical sensor is positioned.

As described above, the lighting unit of the present invention includes: a light source having filament electrodes emitting thermoelectrons; an optical sensor for detecting an electromagnetic wave emitted by the filament electrodes; and driving means for controlling driving of the light source, based on a detected result of the optical sensor.

In a case where an abnormality is caused in the light source having the filament electrode that emits a thermoelectron, the filament electrode emits an electromagnetic wave that is different from an electromagnetic wave to be emitted in the normal state. As such, the arrangement allows the lighting unit of the present invention to cause the optical sensor to detect an electromagnetic wave emitted from the filament electrode, and to control the driving circuit based on the detected result. For example, in a case where a detected result of the optical sensor indicates an electromagnetic wave that is emitted in a case where an abnormality is caused in the light source, the driving means terminates based on the detected result the driving of the light source. As for how the driving means controls the driving of the light source, the driving means not only terminates the driving of the light source, but, according to an electromagnetic wave emitted from the filament electrode, the driving means can also temporarily halt the driving of the light source, decrease an output of the light source, etc.

According to the conventional arrangements, an abnormality caused in the light source is detected by detecting a heat emitted from the filament electrode. As such, it is impossible to detect the abnormality caused in the light source until the heat emitted from the filament electrode reaches the sensor. In contrast, the lighting unit of the present invention causes the optical sensor to detect an electromagnetic wave emitted from the filament electrode, thereby detecting an abnormality caused in the light source. This makes it possible to promptly detect the abnormality caused in the light source. As a result, in a case where a peripheral member made of a material such as a resin is provided in the vicinity of the lighting unit of the present invention, this makes it possible to prevent the peripheral member from deforming, melting, smoking, and/or the like, because of the heat generated by the filament electrode in the light source.

### BRIEF DESCRIPTION OF DRAWINGS

FIG. 1 is a block diagram illustrating a schematic arrangement of a lighting unit of a first embodiment of the present invention.

FIG. 2 is a block diagram illustrating a main part of a driving circuit in the lighting unit.

FIG. 3 is a block diagram illustrating an arrangement in which the lighting unit includes a signal generating section for notifying to the outside occurrence of an abnormality caused in a hot-cathode fluorescent lamp.

FIG. 4 shows graphs each plotting, against an emission intensity of the light, a wavelength of light to be emitted at each of parts of the hot-cathode fluorescent lamp, for a normal state and an abnormal state of the hot-cathode fluorescent lamp in the lighting unit, respectively. (a) shows a graph for the normal state of the hot-cathode fluorescent lamp; (b) shows graphs for the abnormal state of the hot-cathode fluorescent lamp.

FIG. 5 is a cross-sectional view illustrating a schematic arrangement of a liquid crystal display apparatus that includes the lighting unit.

FIG. 6 is a cross-sectional view that illustrates the liquid crystal display apparatus illustrated in FIG. 5 and is a view from a direction orthogonal to the viewing direction of FIG. 5.

FIG. 7 is a block diagram illustrating a schematic arrangement of a lighting unit of a second embodiment of the present invention.

FIG. 8 shows views showing, for each of the normal state and the abnormal state of the hot-cathode fluorescent lamp in the lighting unit, a temperature of a tube wall in the vicinity of a filament electrode in a glass tube. (a) shows a temperature of the tube wall in the normal state of the hot-cathode fluorescent lamp; (b) shows a temperature of the tube wall in the abnormal state of the hot-cathode fluorescent lamp.

FIG. 9 is a graph showing relative emission intensities of infrared rays to be emitted when the tube wall of the hot-cathode fluorescent lamp were at temperatures of 0° C., 25° C., 50° C., 75° C., 100° C., 150° C., and 200° C., respectively. The graph shows the relative emission intensity where an emission intensity of infrared rays emitted at 200° C. is taken as 100%.

FIG. 10 is a block diagram illustrating the lighting unit in which an ultraviolet absorption filter is provided in the vicinity of the filament electrode in an inner wall of the glass tube.

### EXPLANATION OF REFERENCE NUMERALS

1 and 11 Lighting unit
2 and 12 Hot-cathode fluorescent lamp (a light source)
3 and 13 Optical sensor
4 Detector circuit
5 Driving circuit (driving means)
6 Glass tube
7 Filament electrode
8 Controlling section
9 Switching circuit
10 Series LC resonant circuit
14 Transparent section
15 Ultraviolet absorption filter (ultraviolet absorption means)
16 Signal generating section (notifying means)
101 Liquid crystal display apparatus
102 Surface light source apparatus
103 Optical sheet
104 Liquid crystal display panel

### BEST MODE FOR CARRYING OUT THE INVENTION

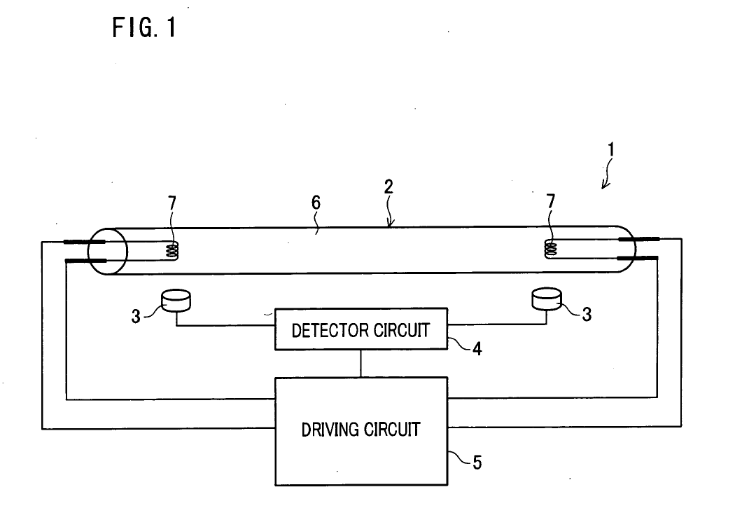

With reference to FIGS. 1 through 10, the following describes one embodiment of the present invention.

A lighting unit of the present invention detects an abnormality caused in a hot-cathode fluorescent lamp by detecting an electromagnetic wave that is emitted from a filament electrode provided in the hot-cathode fluorescent lamp and is different from an electromagnetic wave to be emitted in a normal state of the hot-cathode fluorescent lamp. The electromagnetic wave that is different from the electromagnetic wave to be emitted in the normal state encompasses visible light in an orange spectrum and infrared rays. The following embodiments deal with a lighting unit that detects the visible light in the orange spectrum and a lighting unit that detects infrared rays, respectively.

### First Embodiment

With reference to FIGS. 1 through 6, the following describes a lighting unit 1 of a first embodiment of the present invention. The lighting unit 1 detects an abnormality caused in the hot-cathode fluorescent lamp, based on the visible light that is in the orange spectrum and is emitted from the filament electrode. FIG. 1 is a block diagram illustrating a schematic arrangement of the lighting unit 1 of the present embodiment.

As illustrated in FIG. 1, the lighting unit 1 of the present embodiment includes a hot-cathode fluorescent lamp 2 (a light source), an optical sensor 3, a detector circuit 4, and a driving circuit 5 (driving means).

The lighting unit 1 of the present embodiment is suitably used as a backlight for displaying an image on a liquid crystal display panel of a liquid crystal television, a liquid crystal display apparatus, a liquid crystal display monitor, or the like.

The hot-cathode fluorescent lamp 2 includes a glass tube 6 and a filament electrode 7. The glass tube 6 has a cylindrical shape. An inner wall of the glass tube 6 is entirely coated with a three band (RGB) fluorescent material. Inside each end of the glass tube 6, the filament electrode 7 is provided that is coiled and coated with an electron emissive material. An opening formed at each end of the glass tube 6 is blocked by a base (not illustrated). Examples suitably used as the electron emissive material above encompass oxides of alkali earth metals such as Ba, Ca, and Sr and tungstate of an alkali earth metal.

The filament electrode 7 emits the visible light that is in the orange spectrum and is different from light to be emitted in the normal state, in a case where an abnormality such as a disconnection of the filament electrode 7 due to melting, and exhaustion of the electron emissive material with which the filament electrode 7 is coated is caused in the hot-cathode fluorescent lamp 2.

The optical sensor 3 is a sensor that is capable of detecting the visible light that has a wavelength in the orange spectrum and is emitted from the filament electrode 7 in a case where an abnormality is caused in the hot-cathode fluorescent lamp 2. The optical sensor 3 is provided in the vicinity of the filament electrode 7, which is provided at each end of the glass tube 6. The wavelength of the visible light that is in the orange spectrum and is emitted from the filament electrode 7 falls in a range from approximately 570 nm to approximately 590 nm. As such, it is desired that the optical sensor 3 is capable of detecting a change in intensity of the visible light having a wavelength in the range from approximately 570 nm to approximately 590 nm. As the optical sensor 3, a photodiode or a phototransistor is employable.

The optical sensor 3 may be mounted on an outer wall of the glass tube 6 of the hot-cathode fluorescent lamp 2. Alternatively, the optical sensor 3 may be held in a space outside the hot-cathode fluorescent lamp 2 by an optical sensor holding table. The optical sensor 3 is not necessarily provided in the vicinity of the filament electrode 7, but may be provided in a central part of the glass tube 6. In this case, still, the optical sensor 3 can detect an electromagnetic wave emitted by the filament electrode 7.

However, it should be noted that the optical sensor 3 is preferably provided in the vicinity of the filament electrode 7 because a detected emission intensity of the visible light in the orange spectrum decreases with increasing distance between the optical sensor 3 and the filament electrode 7. Specifically, where any normal, which passes through a center of the filament electrode 7, to a tube wall of the glass tube 6 is taken to have an angle of 0°, it is most preferable that a light-receiving section of the optical sensor 3 is positioned on a straight line that passes through the center and has an angle within ±20° to the normal, and a distance between the light-receiving section of the optical sensor 3 and the outer wall of the glass tube 6 falls in a range from 0 mm to approximately 5 mm.

It may be arranged such that a plurality of optical filters that passes light having a wavelength in the range from approximately 570 nm to approximately 590 nm is provided so as to precede the optical sensor 3, and the plurality of optical filters passes an electromagnetic wave emitted from the filament electrode 7. Of the electromagnetic wave emitted from the filament electrode 7, accordingly, only the light having a wavelength in the range from approximately 570 nm passes through the plurality of optical filters and reaches the optical sensor 3. This allows the optical sensor 3 to detect only the electromagnetic wave having a wavelength in the range from approximately 570 nm to approximately 590 nm. As a result, an abnormality caused in the hot-cathode fluorescent lamp 2 can be detected more surely with higher accuracy.

The detector circuit 4 is a circuit for controlling the driving circuit 5 according to a detected result of the optical sensor 3. Examples suitably used as the detector circuit 4 encompass a circuit that generates a pulse of approximately 5V and a circuit that switches between a Low level output of 0V and a High level output of 5V. For example, in a case where the optical sensor 3 detects that the visible light having a wavelength in the orange spectrum is emitted from the filament electrode 7, the detector circuit 4 causes the driving circuit 5 to terminate the driving of the hot-cathode fluorescent lamp 2. As for how the detector circuit 4 controls the driving circuit 5, the present invention is not limited to the arrangement that the detector circuit 4 causes the driving circuit 5 to terminate the driving of the hot-cathode fluorescent lamp 2. The present invention may be arranged such that, according to an electromagnetic wave that is emitted from the filament electrode 7 and is detected by the optical sensor 3, the detector circuit 4 causes the driving circuit 5 to temporarily halt the driving of the hot-cathode fluorescent lamp 2, or decrease an output of the driving of the hot-cathode fluorescent lamp 2.

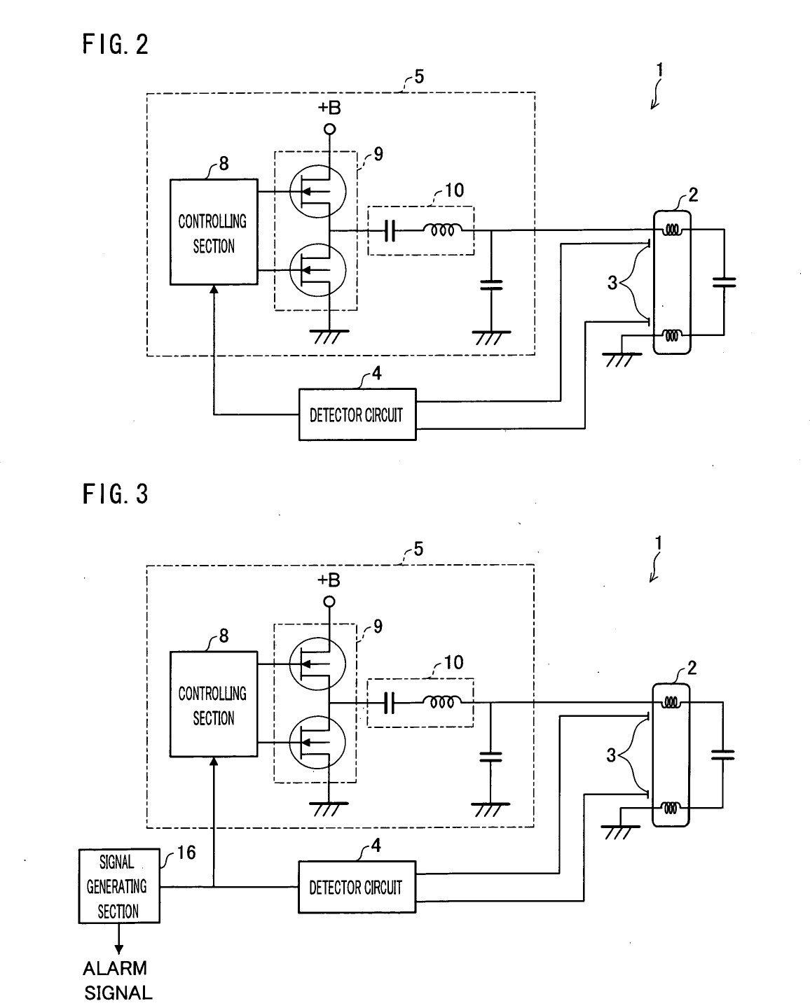

The driving circuit 5 is a circuit for driving the hot-cathode fluorescent lamp 2 and is controlled by the detector circuit 4. Examples suitably used as the driving circuit 5 encompass an inverter circuit such as a series LC oscillator circuit utilizing a half-bridge switching circuit. With reference to FIG. 2 and FIG. 3, the following describes a concrete arrangement of the driving circuit 5. FIG. 2 is a block diagram illustrating a main part of the driving circuit 5 in the lighting unit 1 of the present invention. FIG. 3 is a block diagram illustrating an arrangement in which the lighting unit 1 includes a signal generating section 16 for notifying, to the outside, that an abnormality is caused in the hot-cathode fluorescent lamp 2.

As illustrated in FIG. 2, the driving circuit 5 includes a controlling section 8, a switching circuit 9, and a series LC oscillator apparatus 10.

The control section 8 receives a driving circuit control signal from the detector circuit 4, so as to switch between ON and OFF of the switching circuit 9 that includes two FETs. This controls a voltage to be supplied to the series LC oscillator apparatus 10. The controlling section 8 thus controls the driving of the hot-cathode fluorescent lamp 2. The controlling section 8 is not limited to the arrangement as long as the driving of the hot-cathode fluorescent lamp 2 can be controlled. For example, the controlling section 8 may be so arranged that the driving of the hot-cathode fluorescent lamp 2 is controlled by adjusting current supply to the controlling section 8.

As illustrated in FIG. 3, the lighting unit 1 of the present embodiment may further include the signal generating section 16 (notifying means) for generating an alarm signal. Specifically, in a case where the detector circuit 4 transmits to the driving circuit 5 a signal for terminating the driving of the hot-cathode fluorescent lamp 2 as a driving circuit control signal, the signal generating section 16 generates an alarm signal for notifying, to the outside, that an abnormality is caused in the hot-cathode fluorescent lamp 2 or that the driving of the hot-cathode fluorescent lamp 2 is terminated.

In a case where the lighting unit 1 of the present embodiment is provided in an external apparatus such as a liquid crystal display apparatus, the alarm signal may cause the liquid crystal display apparatus to display a message etc. saying that an abnormality is caused in the lighting unit 1, thereby notifying a user etc. of the liquid crystal display apparatus that the abnormality is caused in the lighting unit 1. This allows the user etc. to promptly deal with the abnormality. As a result, this prevents a problem that the heat generated by the filament electrode 7 affects a peripheral member etc. provided in the vicinity of the lighting unit 1.

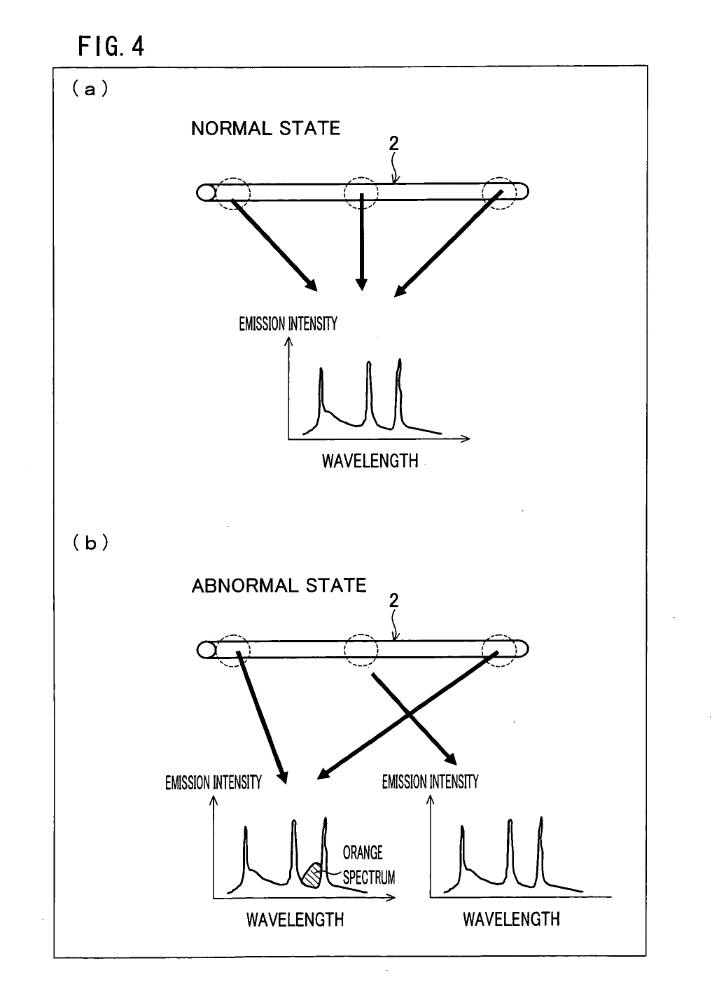

With reference to (a) and (b) of FIG. 4, the following describes the electromagnetic wave to be emitted from the filament electrode 7 in the normal state or the abnormal state of the hot-cathode fluorescent lamp 2. FIG. 4 shows graphs each plotting, against an emission intensity of the light, a wavelength of the light to be emitted at each of parts of the hot-cathode fluorescent lamp 2, for the normal state and the abnormal state of the hot-cathode fluorescent lamp 2, respectively. (a) shows a graph for the normal state of the hot-cathode fluorescent lamp 2; (b) shows graphs for the abnormal state of the hot-cathode fluorescent lamp 2.

In the normal state of the hot-cathode fluorescent lamp 2, as illustrated in (a) of FIG. 4, there is an agreement in relation between a wavelength of an electromagnetic wave to be emitted and an emission intensity of the electromagnetic wave, between the vicinity of the filament electrode 7 provided at each end of the hot-cathode fluorescent lamp 2 and a central part of the hot-cathode fluorescent lamp 2. In contrast, in a case where an abnormality is caused in the hot-cathode fluorescent lamp 2, as illustrated in (b) of FIG. 4, there is a disagreement between (i) a relation between a wavelength of an electromagnetic wave to be emitted from the vicinity of the filament electrode 7 provided at each end of the hot-cathode fluorescent lamp 2 and an emission intensity of the electromagnetic wave and (ii) a relation between a wavelength of an electromagnetic wave to be emitted from the central part of the hot-cathode fluorescent lamp 2 and an emission intensity of the electromagnetic wave.

This is because the filament electrode 7 generates a high temperature in a case where an abnormality is caused in the hot-cathode fluorescent lamp 2, and accordingly, emits the visible light having a wavelength in the orange spectrum. It is necessary to avoid misidentifying a state of a startup of the hot-cathode fluorescent lamp 2 as the abnormal state of the hot-cathode fluorescent lamp 2 because preheating the filament electrode 7 in the startup of the hot-cathode fluorescent lamp 2 can also cause the filament electrode 7 to emit the visible light having a wavelength in the orange spectrum. In general, a time for preheating the filament electrode 7 in the startup of the hot-cathode fluorescent lamp 2 is approximately 1 to 3 seconds. As such, a method for avoiding the misidentification may be arranged such that, in a case where the emission of the visible light in the orange spectrum continues for five seconds or more, the continuous emission is detected as an abnormality caused in the hot-cathode fluorescent lamp 2. Alternatively, the lighting unit 1 may additionally include a switching circuit for terminating the operation of the detector circuit 4 in the startup of the hot-cathode fluorescent lamp 2. With the arrangement, even if the optical sensor 3 detects in the startup of the hot-cathode fluorescent lamp 2 the visible light having a wavelength in the orange spectrum, the driving of the hot-cathode fluorescent lamp 2 will not be wrongly controlled as being that an abnormality is caused in the hot-cathode fluorescent lamp 2.

As described above, the lighting unit 1 of the present embodiment includes the hot-cathode fluorescent lamp 2 having the filament electrode 7 that emits a thermoelectron, the optical sensor 3 for detecting an electromagnetic wave emitted from the filament electrode 7, and the driving circuit 5 for controlling based on a detected result of the optical sensor 3 the driving of the hot-cathode fluorescent lamp 2.

With the arrangement, the lighting unit 1 of the present embodiment causes the optical sensor 3 to detect an electromagnetic wave emitted from the filament electrode 7, thereby detecting an abnormality caused in the hot-cathode fluorescent lamp 2. This makes it possible to promptly detect the abnormality caused in the hot-cathode fluorescent lamp 2. As a result, in a case where a peripheral member made of a material such as a resin is provided in the vicinity of the lighting unit 1 of the present embodiment, this makes it possible to prevent the peripheral member from deforming, melting, smoking, and/or the like, because of the heat generated by the filament electrode 7 in the hot-cathode fluorescent lamp 2. As described above, the lighting unit 1 can promptly terminate the operation of the driving circuit 5 after detecting an abnormality caused in the hot-cathode fluorescent lamp 2. This makes it possible to prevent not only a problem brought by an abnormality caused in the hot-cathode fluorescent lamp 2, but also problems such as no-load operation and overload operation of the driving circuit 5.

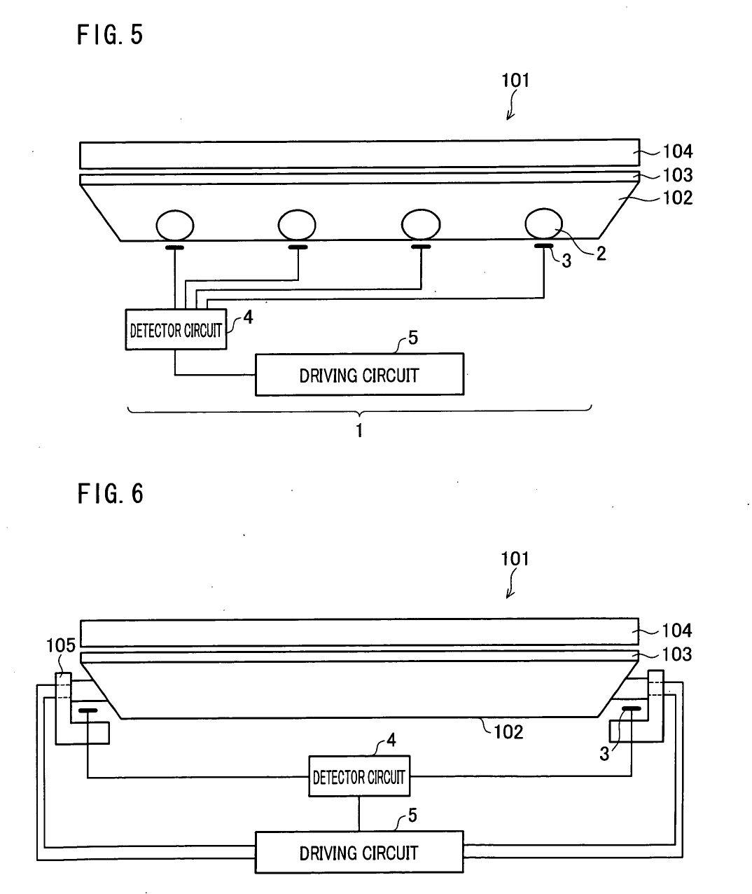

With reference to FIG. 5 and FIG. 6, the following describes a liquid crystal display apparatus utilizing the lighting unit 1 of the present embodiment. FIG. 5 is a cross-sectional view illustrating a schematic arrangement of a liquid crystal display apparatus 101 utilizing the lighting unit 1 of the present embodiment. FIG. 6 is a cross-sectional view that illustrates the liquid crystal display apparatus 101 illustrated in FIG. 5 and is a view from a direction orthogonal to the viewing direction of FIG. 5.

As illustrated in FIG. 5, the liquid crystal display apparatus 101 includes a surface light source apparatus 102 including a plurality of lighting units 1 of the present embodiment, an optical sheet 103, and a liquid crystal display panel 104. For simplicity, FIG. 4 illustrates an arrangement in which the surface light source apparatus 102 includes four lighting units 1. However, the number of the lighting units 1 is not limited to this.

In the liquid crystal display apparatus 101, the plurality of lighting units 1 is provided in parallel to the surface light source apparatus 102. On a top surface of the surface light source apparatus 102, the optical sheet 103 and the liquid crystal display panel 104 are stacked in this order. That is, the surface light source apparatus 102 functions as a backlight of the liquid crystal display apparatus 101. In each of the plurality of lighting units 1 provided to the surface light source apparatus 102, the optical sensor 3 is provided in the vicinity of the filament electrode 7 in the hot-cathode fluorescent lamp 2 in the lighting unit 1. Every optical sensor 3 is connected to one detector circuit 4. The detector circuit 4 is connected to one driving circuit 5. The driving circuit 5 controls the driving of all hot-cathode fluorescent lamps 2 in the lighting unit 1 provided to the surface light source apparatus 102.

Examples suitably used as the liquid crystal display panel 104 encompass an active-matrix color liquid crystal panel utilizing TFTs. FIG. 5 and FIG. 6 illustrate a direct backlight unit. However, the lighting unit 1 of the present embodiment is also applicable to an edge light type backlight unit utilizing a light guide plate and an optical sheet.

As illustrated in FIG. 6, it may be arranged such that the hot-cathode fluorescent lamp 2 of the lighting unit 1 in the liquid crystal display apparatus 101 is held by a lamp holding table 105 and the optical sensor 3 is mounted on the lamp holding table 105. Examples suitably used as the lamp holding table 105 encompass a resin case having a socket in which a filament electrode 7 part of the hot-cathode fluorescent lamp 2 is fitted, and a printed circuit board having a socket thereon. The hot-cathode fluorescent lamp 2 and the driving circuit 5 are connected with each other via the lamp holding table 105.

In general, the hot-cathode fluorescent lamp 2 is held by a holding table or the like because the hot-cathode fluorescent lamp 2 is formed of the glass tube 6 having a cylindrical shape. The optical sensor 3 is provided on an outer wall of the glass tube 6 of the hot-cathode fluorescent lamp 2 or provided in a space outside the hot-cathode fluorescent lamp 2. In a case where the optical sensor 3 is provided in the space outside the hot-cathode fluorescent lamp 2, the optical sensor 3 is held by the optical sensor holding table or the like.

Holding the hot-cathode fluorescent lamp 2 by the lamp holding table 105 and mounting the optical sensor 3 on the lamp holding table 105 make it possible to combine the holding table for holding the hot-cathode fluorescent lamp 2 and the optical sensor holding table. This makes it possible to reduce the number of members of the lighting unit 1 of the present embodiment. In addition, the arrangement makes it possible to position the optical sensor 3 in the vicinity of the filament electrode 7. As a result, the optical sensor 3 can detect with high sensitivity an abnormality caused in the hot-cathode fluorescent lamp 2.

### Second Embodiment

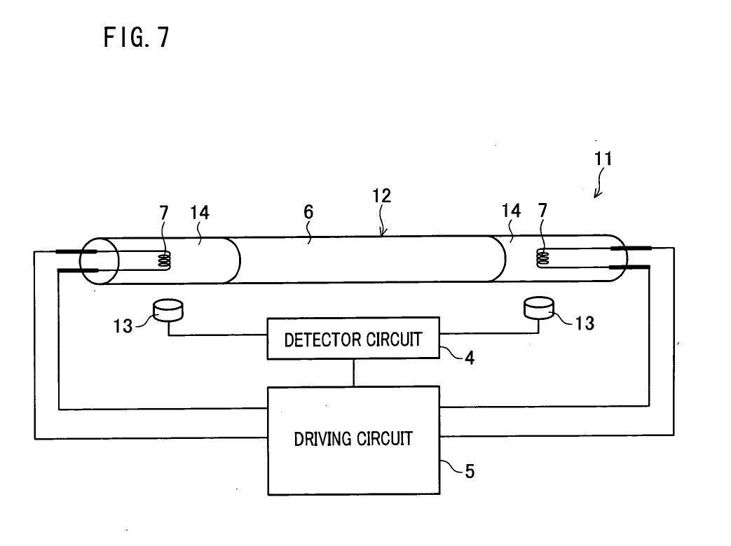

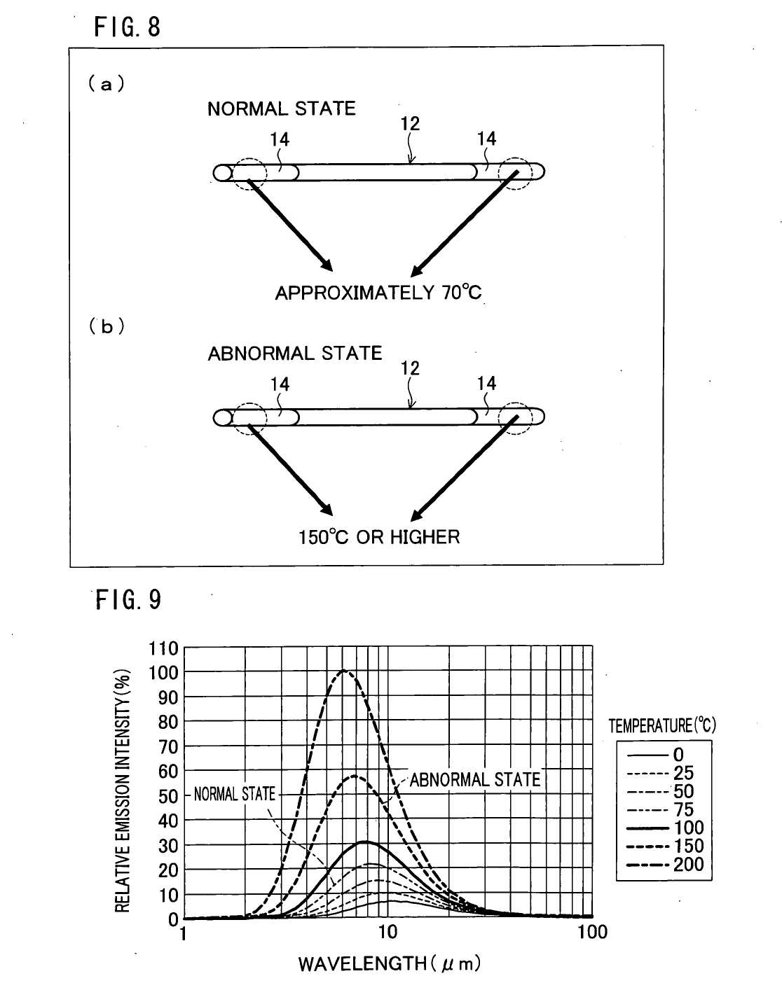

With reference to FIG. 7 and FIG. 8, the following describes a lighting unit 11 of a second embodiment of the present invention that lighting unit 11 detects an abnormality caused in a hot-cathode fluorescent lamp, based on infrared rays that are emitted from a filament electrode. FIG. 7 is a block diagram illustrating a schematic arrangement of the lighting unit 11 of the present embodiment.

As illustrated in FIG. 7, the lighting unit 11 of the present embodiment includes a hot-cathode fluorescent lamp 12, a infrared sensor 13, a detector circuit 4, and a driving circuit 5. In the present embodiment, members having the same functions as those of the members of the lighting unit 1 of the first embodiment are given the same reference numerals, and descriptions for the members of the present embodiment are omitted.

As is the case with the hot-cathode fluorescent lamp 2 in the first embodiment, the hot-cathode fluorescent lamp 12 is arranged such that an inner wall of a glass tube 6 is coated with a three band (RGB) fluorescent material, except that a transparent section 14 that is not coated with the fluorescent material is provided in the vicinity of a filament electrode 7 provided at each end of the glass tube 6. In FIG. 7, the transparent section 14 is provided on the inner wall of the glass tube 6 so as to cover an entire circumference of the glass tube 6. However, the present invention is not limited to the arrangement, but may be arranged such that the transparent section 14 is provided only in an area near the infrared sensor 13. The reason for this is that, in a case where the inner wall of the glass tube 6 of the hot-cathode fluorescent lamp 12 is coated with the fluorescent material along the entire circumference of the glass tube 6, almost infrared rays emitted from the filament electrode 7 is absorbed by the fluorescent material. As such, the transparent section 14 is so arranged that the infrared rays emitted from the filament electrode 7 can reach the infrared sensor 13, without passing the fluorescent material.

Since the vicinity of the filament electrode 7 is not an effective light emission area of the hot-cathode fluorescent lamp 12, a luminance of the hot-cathode fluorescent lamp 12 is hardly affected by the provision of the transparent section 14, which is not coated with the fluorescent material.

The infrared sensor 13 is a sensor for detecting invisible light in a long wavelength region, and is provided in the vicinity of the filament electrode 7 provided at each end of the glass tube 6. As described above, the infrared sensor 13 is a sensor for detecting invisible light in the long wavelength region. However, the infrared sensor 13 is not limited to this, but may be arranged so as to detect a change in intensity of infrared rays having a wavelength in the range from approximately 0.8 μm to approximately 10 μm. This makes it possible to use as the infrared sensor 13 an inexpensive sensor whose detection wavelength is approximately 0.8 μm and that is used for an infrared remote control. In a case where the sensor whose detection wavelength is approximately 0.8 μm is used as the infrared sensor 13, a malfunction due to a noise etc. can be easily caused because the filament electrode 7 emits a small amount of the infrared rays. Therefore, it is preferable to amplify with an amplifier the infrared rays detected by the infrared sensor 13.

The infrared sensor 13 is not necessarily provided in the vicinity of the filament electrode 7, but is preferably provided in the vicinity of the filament electrode 7 because a detected emission intensity of the infrared rays decreases with increasing distance between the infrared sensor 13 and the filament electrode 7.

The following describes an arrangement in which the infrared sensor 13 detects infrared rays, thereby detecting an abnormality caused in the hot-cathode fluorescent lamp 12. First, with reference to (a) and (b) of FIG. 8, the following describes heat generated by the filament electrode 7 in a normal state and an abnormal state of the hot-cathode fluorescent lamp 12. FIG. 8 shows views showing, for each of the normal state and the abnormal state of the hot-cathode fluorescent lamp 12, a temperature of a tube wall in the vicinity of the filament electrode 7 in the glass tube 6. (a) shows a temperature of the tube wall in the normal state of the hot-cathode fluorescent lamp 12; (b) shows a temperature of the tube wall in the abnormal state of the hot-cathode fluorescent lamp 12.

As illustrated in (a) of FIG. 8, in the normal state of the hot-cathode fluorescent lamp 12, a temperature of the tube wall in the vicinity of the filament electrode 7 in the glass tube 6 is approximately 70° C. in a case where, for example, the hot-cathode fluorescent lamp 12 is so arranged that: an ambient temperature is set to 25° C.; a tube diameter is set to 15.5 mm; and a tube length is set to 820 mm, and the hot-cathode fluorescent lamp 12 is driven at a lamp current of 150 mA and a filament current of 50 mA. As illustrated in (b) of FIG. 8, in the abnormal state of the hot-cathode fluorescent lamp 12, a temperature of the tube wall in the vicinity of the filament electrode 7 in the glass tube 6 is a high temperature of 150° C. or higher.

As described above, a temperature of the heat generated by the filament electrode 7 differs between the normal state and the abnormal state of the hot-cathode fluorescent lamp 12. An emission intensity of the infrared rays differs according to a temperature of the heat generated by the filament electrode 7. In view of this, the lighting unit 11 of the present embodiment is arranged such that an abnormality caused in the hot-cathode fluorescent lamp 2 is detected by measuring a difference between emission intensities of the infrared rays, based on a temperature difference produced by the filament electrode 7 between the normal status and the abnormal status of the hot-cathode fluorescent lamp 12.

With reference to FIG. 9, the following describes a relation between a temperature difference of a tube wall in the vicinity of the filament electrode 7 in the hot-cathode fluorescent lamp 12 and an emission intensity of the infrared rays. FIG. 9 is a graph showing a relative emission intensity of infrared rays to be emitted at each of temperatures of the tube wall of the hot-cathode fluorescent lamp 12 where the temperatures are 0° C., 25° C., 50° C., 75° C., 100° C., 150° C., and 200° C. The graph shows the relative emission intensity where an emission intensity of infrared rays emitted at 200° C. is taken as 100%.

A spectrum distribution in FIG. 9, which is determined by a temperature of the tube wall and emitted infrared rays, is found by the following equation based on Planck's radiation law, independently of infrared absorption of glass.

E(λ·T)=(C1/λ5)·[1/{exp(C2/λT)−1}]

E is a radiant energy density (W/m²); λ is a wavelength (m); T is the absolute temperature (K); C1 is the first radiation constant (3.7415×10⁻¹⁵ W/m²); C2 is the second radiation constant (1.43879×10⁻² m/K).

As FIG. 9 shows, the higher a temperature of the tube wall of the hot-cathode fluorescent lamp 12, the higher an emission intensity of the infrared rays to be emitted. The infrared sensor 13 detects an abnormality caused in the hot-cathode fluorescent lamp 12 by detecting a difference between emission intensities at corresponding temperatures.

The graph in FIG. 9 shows that peaks of emission intensities at respective temperatures fall in a wavelength range from approximately 4 μm to 10 μm. In the wavelength range, a large amount of infrared rays is emitted at each of the temperatures. Therefore, a difference between emission intensities is significant in the wavelength range. As such, the infrared sensor 13 is preferably realized by a sensor whose detection wavelength covers a range from approximately 4 μm to approximately 10 μm. In a case where detection wavelengths of the infrared sensor 13 cover a wavelength range from approximately 4 μm to approximately 10 μm, A malfunction due to a noise etc can become negligible because a large amount of infrared rays is emitted in the wavelength range. In addition, an emission intensity of the infrared rays differs nearly double between the normal state and the abnormal state of the hot-cathode fluorescent lamp 12. This makes it possible to detect with high accuracy an abnormality caused in the hot-cathode fluorescent lamp 12.

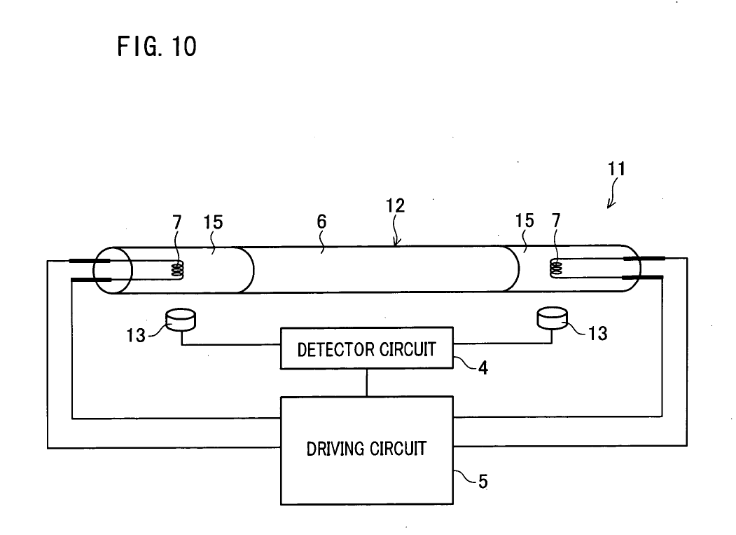

As illustrated in FIG. 10, the hot-cathode fluorescent lamp 12 may be arranged such that a film-like ultraviolet absorption filter 15 (ultraviolet absorption means) is affixed onto the transparent section 14 of the hot-cathode fluorescent lamp 12.

The hot-cathode fluorescent lamp 12 emits light in such a manner that a discharge is caused by the filament electrode 7, thereby ultraviolet rays being emitted, and the ultraviolet rays activate the fluorescent material with which the inner wall of the glass tube 6 is coated, thereby the visible light specific to the fluorescent material being emitted by the fluorescent material. In a case where, for example, a peripheral member made of a material such as a resin is provided in the vicinity of the lighting unit 11 of the present embodiment, the peripheral member becomes deteriorated by being irradiated with the ultraviolet rays.

In view of this, the ultraviolet absorption filter 15 is affixed onto the transparent section 14 of the hot-cathode fluorescent lamp 12. With this arrangement, the ultraviolet rays emitted from the hot-cathode fluorescent lamp 12 can be absorbed by the ultraviolet absorption filter 15. As a result, this makes it possible to prevent deterioration of the peripheral member that is made of a material such as a resin and is provided in the vicinity of the lighting unit 11 of the present embodiment.

The ultraviolet absorption filter 15 is not limited to the arrangement above, but may be arranged in any way, provided that the ultraviolet rays emitted from the filament electrode 7 cannot be emitted to the outside of the hot-cathode fluorescent lamp 12.

The hot-cathode fluorescent lamp 12 of the present embodiment can be used instead of the hot-cathode fluorescent lamp 2 in the lighting unit 1 of the first embodiment. The hot-cathode fluorescent lamp 12 of the present embodiment includes the transparent section 14 for suppressing the absorption of the infrared rays emitted from the filament electrode 7. In this relation, in the lighting unit 1 of the first embodiment, the fluorescent material with which the inner wall of the glass tube 6 is coated intercepts a part of the visible light that has a wavelength in the orange spectrum and is emitted from the filament electrode 7. In the vicinity of the filament electrode, the fluorescent material coating the inner wall of the glass tube 6 does not greatly contribute to the light emission of the hot-cathode fluorescent lamp.

However, applying the hot-cathode fluorescent lamp 12 of the present embodiment to the lighting unit 1 of the first embodiment makes it possible to prevent the fluorescent material with which the inner wall of the glass tube 6 is coated from absorbing the visible light that has a wavelength in the orange spectrum and is emitted by the filament electrode 7. As a result, the optical sensor 3 of the first embodiment can detect more surely with higher accuracy an electromagnetic wave emitted from the filament electrode 7. It is also possible to apply to the lighting unit 1 of the first embodiment the hot-cathode fluorescent lamp 12 in which the ultraviolet absorption filter 15 is affixed onto the transparent section 14.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present invention is suitably applicable to a backlight for displaying an image on a liquid crystal display panel of a liquid crystal television, a liquid crystal display apparatus, a liquid crystal display monitor, and the like.

1. A lighting unit comprising:
a light source having filament electrodes emitting thermoelectrons; an optical sensor for detecting an electromagnetic wave emitted by the filament electrodes; and
driving means for controlling driving of the light source, based on a detected result of the optical sensor.

2. The lighting unit as set forth in claim 1, wherein:
the light source includes each of the filament electrodes inside each of both ends of a cylindrical glass tube; and
the glass tube has an inner wall coated with a fluorescent material, except for a part in the vicinity of the filament electrode.

3. The lighting unit as set forth in claim 1, wherein:
the optical sensor detects a change in intensity of visible light having a wavelength in a range from approximately 570 nm to approximately 590 nm.

4. The lighting unit as set forth in claim 3, wherein:
the driving means terminates the driving of the light source in a case where the optical sensor detects that the intensity of the visible light having the wavelength in the range from approximately 570 nm to approximately 590 nm exceeds a predetermined threshold.

5. The lighting unit as set forth in claim 2, wherein
the optical sensor detects a change in intensity of infrared rays having a wavelength in a range from approximately 0.8 μm to approximately 10 μm.

6. The lighting unit as set forth in claim 5, wherein
the driving means terminates the driving of the light source in a case where the optical sensor detects that the intensity of the infrared rays having the wavelength in the range from approximately 0.8 μm to approximately 10 μm exceeds a predetermined threshold.

7. The lighting unit as set forth in claim 4, comprising notifying means for notifying, to the outside, that an abnormality is caused in the light source, the notifying means performing the notification in a case where the driving means terminates the driving of the light source.

8. The lighting unit as set forth in claim 2, comprising:
ultraviolet absorption means on that part of the inner wall of the glass tube, which is uncoated with the fluorescent material.

9. The lighting unit as set forth in claim 2, wherein:
at least the both ends of the glass tube of the light source are held by a holding table; and
the optical sensor is mounted on the holding table.

10. A liquid crystal display apparatus comprising, as a backlight, a lighting unit recited in claim 1.

11. The lighting unit as set forth in claim 2, wherein:
the optical sensor detects a change in intensity of visible light having a wavelength in a range from approximately 570 nm to approximately 590 nm.

12. The lighting unit as set forth in claim 6, comprising notifying means for notifying, to the outside, that an abnormality is caused in the light source, the notifying means performing the notification in a case where the driving means terminates the driving of the light source.

13. The lighting unit as set forth in claim 11, wherein:
the driving means terminates the driving of the light source in a case where the optical sensor detects that the intensity of the visible light having the wavelength in the range from approximately 570 nm to approximately 590 nm exceeds a predetermined threshold.

14. The lighting unit as set forth in claim 13, comprising notifying means for notifying, to the outside, that an abnormality is caused in the light source, the notifying means performing the notification in a case where the driving means terminates the driving of the light source.
